(19) United States
(12) Patent Application Publication
(10) Pub. No.: US 2010/0179053 A1
(43) Pub. Date: Jul. 15, 2010

(54) METAL OXIDE NANOTUBE-SUPPORTED GOLD CATALYST AND PREPARING METHOD THEREOF

(75) Inventors: Chiu-Hsun LIN, CHANGHUA CITY (TW); Jui-Ying TSAI, CHANGHUA CITY (TW)

Correspondence Address: BRIAN M. MCINNIS, 12th Floor, Ruttonjee House, 11 Duddell Street, Hong Kong, HK

(73) Assignee: NATIONAL CHANGHUA UNIVERSITY OF EDUCATION, CHANGHUA CITY (TW)

(21) Appl. No.: 12/554,926

(22) Filed: Sep. 7, 2009

(30) Foreign Application Priority Data
Jan. 15, 2009 (TW) 98101442

(51) Int. Cl. B01J 37/30; B01J 23/52

(52) U.S. Cl. 502/11; 502/344; 977/811

(57) ABSTRACT

A metal oxide nanotube-supported gold catalyst and a preparing method thereof are disclosed. The metal oxide nanotube-supported gold catalyst includes a metal oxide support and a plurality of gold particles loaded into the metal oxide support, and there are at least two gold species with different oxidation states are loaded into the metal oxide support. The preparing method of the metal oxide nanotube-supported gold catalyst includes the deposition of the gold particles on the surface of the metal oxide nanotubes by using an ion exchange reaction.

### RELATED APPLICATIONS

The application claims priority to Taiwan Application Serial Number 98101442, filed Jan. 15, 2009, which is herein incorporated by reference.

### BACKGROUND

1. Field of Invention

The present invention relates to a gold catalyst. More particularly, the present invention relates to a metal oxide nanotube-supported gold catalyst and a preparing method for the same.

2. Description of Related Art

Gold is normally regarded as an inert noble metal for catalytic purposes. Nevertheless, in the late 1980s, Haruta reported that a supported gold catalyst was able to catalyze the oxidation of CO to CO₂ even at 203 K. Since then, there has been a surge in the number of papers published in this field to investigate the mysterious catalytic effect of such gold catalyst. Intensive research efforts have been concentrating on using various preparation techniques to prepare supported gold particles, such as co-precipitation, co-sputtering, chemical vapor deposition, impregnation, grafting, photodeposition, physical mixing, low-energy cluster beam deposition, adsorption of gold colloids on metal oxides, and ion exchange.

Although small gold particles are active for CO oxidation, the oxide support definitely plays a role. It had been demonstrated that the support affected the dispersion and shape of the gold particles. In addition, the presence of defect sites on the surface of the oxide support was known to provide sites for nucleation and growth of metal particles. Both non-reducible metal oxides (such as γ-Al₂O₃, MgO, SiO₂) and reducible metal oxides (such as Fe₂O₃, CeO₂, and TiO₂) had been utilized as support materials to prepare active supported gold catalysts.

Furthermore, it has been widely recognized that only the preparation method able to produce gold particles with a size smaller than 5 nm on oxide supports can lead to a good performance catalyst. There is also a consensus in the literature that the choice of support affects the reaction pathway of the supported gold catalyst.

For example, the mode of supplying O₂ to the active center in the gold catalyst is different over reducible oxide supports and non-reducible oxide supports. The effects imposed by the preparation methods and the supports might also interact with each other, adding more complexity to the research. For instance, using impregnation method with HAuCl₄ to prepare Au/TiO₂ resulted in a large Au particle (>20 nm) and less active catalyst after thermal treatment to form the metallic gold particles. The formation of large gold particles was attributed to both the weak interaction between the HAuCl₄ and the support and the presence of chlorides in the catalyst to promote the sintering of the gold particles during the thermal treatment.

Recently, Kasuga reported a preparation of a mesoporous sodium titanate nanotube (NaTNT) using a hydrothermal method, in which TiO₂ powder was treated in a concentrated NaOH solution at the elevated temperatures. Due to the phase composition of the nanotube might be affected by preparation conditions, a number of crystal structures had been proposed for the titanate nanotube, such as dititanate (Na₂Ti₂O₄(OH)₂), trititanate (Na₂Ti₃O₇), tetratitante (Na₂Ti₄O₈(OH)₂), and lepidocrocite (HₓTi_{2-x/4□x}/₄O₄H₂O, x=0.7, □=vacancy). It is known that alkali metal titanates with a layered structure are good ion exchangers. Ion exchange has been a useful technique to prepare highly dispersed precious metal catalysts in heterogeneous catalysis. Nevertheless, there are very few reports to explore the ion exchange ability of the newly synthesized NaTNT.

### SUMMARY

The present invention is directed to a metal oxide nanotube-supported gold catalyst and a preparing method thereof to form a gold catalyst capable of catalyzing carbon monoxide to carbon dioxide at low temperature.

The preparing method of the metal oxide nanotube-supported gold catalyst comprises carrying out an ion exchange reaction of cationic gold to deposit the small gold particles in a range from about 0.5 nm to about 10 nm on a titanate nanotube surface.

According to embodiments of the present invention, at least two-gold species with different oxidation states may load into the titanate nanotubes. In one embodiment, three gold species with different oxidation states of Au⁰, Auₙ₊ (n=1 or 3), and Au^{δ-} are loaded into a sodium titanate nanotube (NaTNT) support surface. The Auⁿ⁺ species play an important role in the activity in the sub-ambient temperature region.

According to another embodiment of the present invention, the maximum amount of gold loading on the NaTNT is 40.2 weight percent. The gold particle sizes are in a range from about 0.5 nm to 5.5 nm.

In conclusion, the AuNaTNT catalyst of one embodiment of the present invention allows catalyzing carbon monoxide to carbon dioxide at low temperature, and the temperature for 50% CO conversion (T_{50%}) is 218 K.

### BRIEF DESCRIPTION OF THE DRAWINGS

The invention can be more fully understood by reading the following detailed description of the embodiments, with reference made to the accompanying drawings as follows:

FIG. 1 (a) is an FE-SEM image of a starting material for NaTNT preparation according to one embodiment of the invention; (b) is an FE-SEM image of the prepared NaTNT that used the starting material shown in (a); (c) is a HRTEM image of the NaTNT that is shown in (b); (d) is a HRTEM image of the gold particles and the lattice fringe of the AuNaTNT catalyst that was dried at 383 K.

FIG. 2(a) is a TEM image of the AuNaTNT catalyst (Au383-S383-2.53) of an embodiment of the present invention; and (b) is a diagram of the gold particle size distributions of the AuNaTNT catalyst shown in (a).

FIG. 3 is a diagram of the pore size distributions of NaTNT calcined at various temperatures. The pore size distributions of the NaTNT that were calcined at 383 K, 473 K, 573 K, and 673 K are exhibited in curves (a), (b), (c), and (d), respectively.

FIG. 4 is XRD spectrum of the gold catalysts prepared by a hydrothermal method and washed in deionized water, and FIG. 4(a)-4(d) are XRD spectra for NaTNT calcined at 383K, 473K, 573K, and 673K, respectively.

FIG. 5 is XRD spectra for (a) AuNaTNT dried at 383K (Au383-S383-2.53) and for the catalyst (Au383-S673-2.20) calcined for 3 h at (b) 383K, (c) 473K, (d) 573K, and (e) 673K. Insert includes the expanded peaks at 2θ=77.50 to estimate the particle sizes in spectra (b)-(e).

FIG. 6 is a diagram of the CO conversions and the corresponding temperature profiles for an active AuNaTNT catalyst containing 2.53 wt % Au.

FIG. 7 is a diagram of the CO conversions and the corresponding temperature profiles for AuNaTNT catalysts with different Au loadings.

FIG. 8 is a diagram comprises the TEM images and the Au particle size distributions of two AuNaTNT catalysts with different Au loadings. FIG. 8 (a) shows the morphology of an AuNaTNT catalyst with 1.39 wt % Au; (b) is the Au particle size distributions in the (a); (c) shows the morphology of an AuNaTNT catalyst with 0.39 wt % Au; and (d) is the Au particle size distributions in the (c).

FIG. 9 is a diagram of the variation in CO conversions with respect to the NaTNT supports calcination temperatures (383 K-673 K) of various AuNaTNT catalysts.

FIG. 10 is a DRIFT spectrum of NaTNT supports calcined at various temperatures for (a) 383 K, (b) 473 K, (c) 573 K, and (d) 673 K.

FIG. 11 is a diagram of variation of CO conversions with gold calcination temperature (Tₒ) for an AuNaTNT catalyst (Au383-S673-2.20) calcined from 383 K to 673 K.

FIG. 12 is a diagram comprises the TEM images and the variation of gold particle size distributions with different gold calcination temperatures. FIG. 12 (a) is the TEM image of AuNaTNT calcined at 473 K, and (b) is the gold particle size distributions in the (a); (c) is the TEM image of AuNaTNT calcined at 673 K, and (d) is the particle size distributions in (c).

FIG. 13 is a diagram of variation of XPS signals of gold with calcination temperature of gold particles (Tₒ). The Au loading used in this experiment was 2.2 wt % and the NaTNT support was calcined at 673K before ion exchange with gold.

### DETAILED DESCRIPTION

In the following description, specification details are set forth such as specific quantities, sizes, etc. so as to provide a thorough understanding of embodiments of the present invention. However, it will be obvious to those skilled in the art that the present invention may be practiced without such specific details. In many cases, details concerning such considerations and the like have been omitted inasmuch as such details are not necessary to obtain a complete understanding of the present invention and are within the skills of persons of ordinary skill in the relevant art.

The metal oxide nanotube-supported gold catalyst, according to an embodiment of the present invention, was prepared by reacting a metal oxide (such as Nb₂O₅, TiO₂) with a concentrated sodium hydroxide solution to form a plurality of metal oxide nanotubes; and gold cations could be loaded into the metal oxide nanotubes by ion exchange.

The following example is provided to demonstrate an embodiment of the present invention. It should be appreciated by those of skill in the art that the method disclosed in the example that follows merely represent an exemplary embodiment of the present invention. However, those of skill in the art should, in light of the present disclosure, appreciate that many changes can be made in the specific embodiment described and still obtain a like or similar result without departing from the spirit and scope of the present invention.

### Example

The exemplary metal oxide of one embodiment is titanium dioxide, therefore titanate nanotubes, such as sodium titanate nanotubes (NaTNT), was employed as a support of the gold catalyst. The sodium titanate nanotubes with a layered structure are good ion exchangers, thus capable of loading gold cations by ion exchange.

According to the embodiment of the present invention, to prepare sodium titanate nanotube, the anatase TiO₂ powder was mixed with 5-15 M NaOH at a ratio about 1 g/400 ml. In one exemplary embodiment, 1.5 g of anatase TiO₂ powder was mixed with 600 ml of 5-15 M NaOH in a 1.0 L container, and the mixture was kept at 353-423 K for 4-7 days with vigorous stirring. The resulting slurry was filtered and washed with deionized water. The washed product was filtered and further dried at 383 K overnight to yield a NaTNT cake. According to embodiments of the present invention, the metal oxide powder is considered to include at least one titanium dioxide polymorphs, such as brookite, anatase, rutile, and combinations thereof.

The NaTNT was further calcined within a temperature range from 473 K to 773 K in ambient air for 3 hours under a heating rate of 1-10 K/min. Then, an appropriate amount of the gold cation (Auⁿ⁺, n=1 and 3), such as AuCl₃, was mixed with 250 ml of deionized water, into which 0.50 g of NaTNT was added and stirred for 24 hours at room temperature to form a suspended mixture. In order to eliminate the adsorption of chloride ions, the pH value of the suspended mixture may titrate to pH=7 to pH=12 by using 0.1 M NaOH solution to lower the zeta potential of NaTNT. In one embodiment of the present invention, the pH value of the suspended mixture is 10. According to embodiments of the present invention, the use of cationic gold is determined by desired loading amount of gold. In general, about 50%-85% of the calculated amount of cationic gold could be loaded into the titanate nanotube supports with the above preparation procedure. As the gold cations exchange processing, the gold loading percentage is increasing. In theory, the maximum amount gold can load into the titanate nanotube support reaches 40.2 weight percent. For improving the ion exchange efficiency, the temperature of the ion exchange process was raised up to 70-80° C. to enhance the rate of gold loading. In another embodiment of the present invention, to increase the gold loading amount, the ion exchange reaction may repeat until more anchoring sites of the gold particles on the titanate nanotube support are occupied. After the ion exchange, the resulting suspended mixture was filtered, and the obtained solid was washed with deionized water and dried at 383 K for 1 h to yield a pale yellow powder.

To examine the effect of calcination temperature on the gold particles, the pale yellow powder was calcined again as previously from 473 K to 773 K, yielding AuNaTNT catalyst with a purple color. The catalyst was labeled as AuT1-ST2-wt % of Au, where AuT1 and ST2 denoted the calcination temperatures of gold precursor and of NaTNT support, respectively. For example, an AuNaTNT catalyst is denoted “Au383-S473-2.50” indicates the AuNaTNT catalyst containing 2.50 wt % Au supported on an NaTNT support calcined at 473 K, and the loaded Au were treated with 383 K calcination temperatures. The gold complex used to prepare the supported gold catalyst would be decomposed by light and that the size of the gold metal particle would increase when exposed to light or ambient air (due to its moisture content) during storage. Therefore, all the experimental procedures including preparation, characterization and catalytic activity measurements should be conducted in the absence of light as much as possible, and the prepared AuNaTNT catalysts were stored in brown bottles under dry N₂ atmosphere and placed in the dark.

### Characterization of NaTNT and AuNaTNT

The starting material that was used to prepare NaTNT and the prepared NaTNT were observed by using a field-emission scanning electron microscope (FE-SEM).

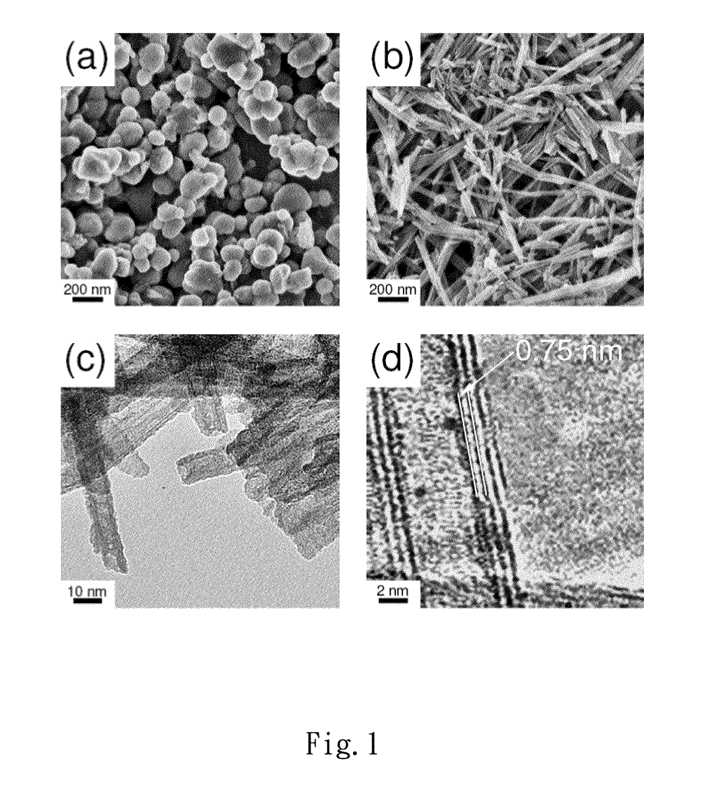

FIG. 1 (a) is a FE-SEM image of a starting material of NaTNT preparation according to one embodiment of the invention. FIG. 1(a) shows the starting material, anatase TiO₂ powder, comprises round particles of sizes 50-250 nm.

FIG. 1(b) is an FE-SEM image of the prepared NaTNT that used the starting material shown in FIG. 1(a). The FE-SEM sample of FIG. 1b is the NaTNT that prepared by hydrothermal method and washing in deionized water and drying at 383 K. The image shows that the hydrothermal product consists of many fiber-like materials with diameters of 20-150 nm and lengths of up to a micrometer.

FIG. 1(c) is a high-resolution transmission electron microscope (HRTEM) image of the NaTNT that shown in FIG. 1(b). FIG. 1(c) shows that each fiber-like NaTNT comprising an outer diameter in a range from about 8 nm to about 12 nm, and a hollow inside diameter in a range from about 3 nm to about 5 nm. Some nanotube-bundle with larger diameters composed of a few NaTNT binding to each other is observed.

FIG. 1(d) is a HRTEM image of the gold particles and the lattice fringe of the AuNaTNT catalyst that was dried at 383 K. FIG. 1(d) shows a section of the nanotube loaded with a plurality of spherical gold nanoparticles, and the AuNaTNT catalyst of the embodiment has an outer diameter around 9 nm and a hollow inside diameter of 4.5 nm. The AuNaTNT catalyst has a lattice fringe of 0.75 nm, whose value is the interplanar distance of (200) lattice plane of a sodium trititanate (Na₂Ti₃O₇).

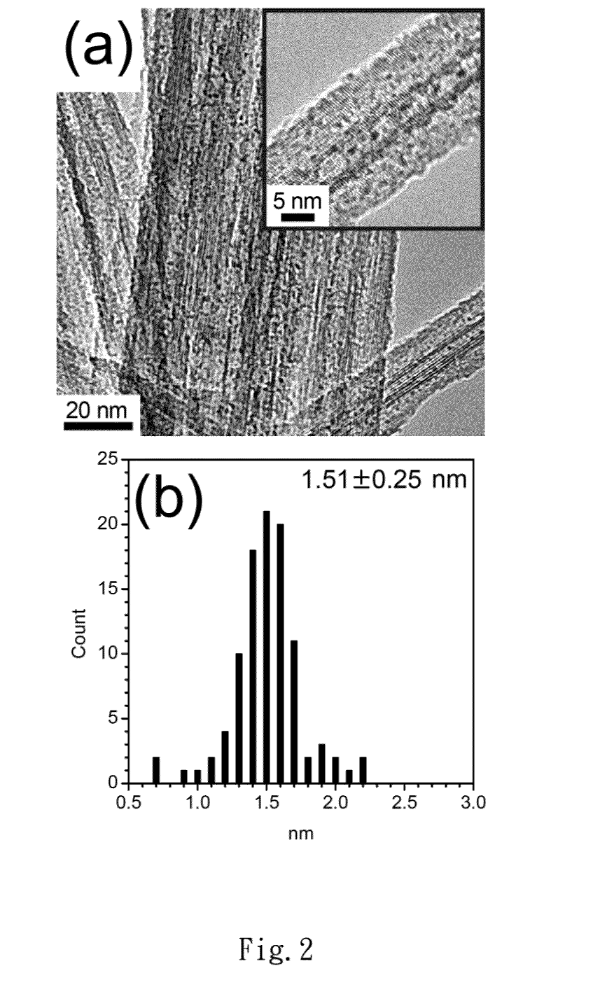

FIG. 2(a) is a transmission electron microscope (TEM) image of the AuNaTNT catalyst (Au383-S383-2.53) of an embodiment of the present invention. FIG. 2(a) shows the gold particles are distributed quite homogeneously on the NaTNT surface, indicating no preference of gold anchoring sites.

FIG. 2(b) is a diagram of the gold particle size distributions of the AuNaTNT catalyst shown in FIG. 2(a). FIG. 2(b) shows the gold particle size deposited by the ion exchange method on NaTNT is rather small and the average gold particle size observed in HRTEM was about 1.51±0.25 nm. Furthermore, the gold particle size distributions are quite narrow, and most of the gold particles have diameters within a range from 1.0 to 2.0 nm.

### Surface Area and Pore Structure Characterization of NaTNT and Au NaTNT

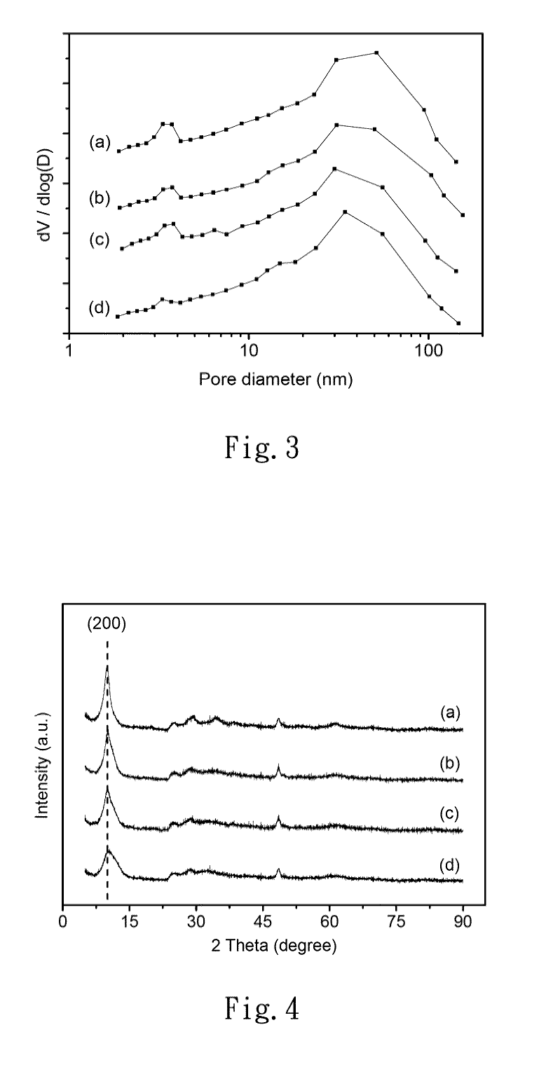

FIG. 3 is a diagram of the pore size distributions of NaTNT calcined at various temperatures. The pore size distributions of the NaTNT that were calcined at 383 K, 473K, 573K, and 673 K are exhibited in curves (a), (b), (c), and (d), respectively. The pore diameter was measured by BET method based on adsorption of N₂ on NaTNT surface.

FIG. 3 reveals a bipolar distribution of pore diameters, whose maximum are located at 3-5 nm and 30-50 nm, respectively. The smaller pores of 3-5 nm corresponds to the inside diameters of the NaTNT, and the larger pores of 40-50 nm are the space between the nanotubes in a bundle of nanotubes and the neighboring bundles. Furthermore, when these nanotubes were calcined at 673 K, the volume of small pores was shrunk significantly but that of the large pores decreased only slightly.

Refer to Table 1. Table 1 summarizes the physical properties of the NaTNT and the AuNaTNT catalyst after various calcination temperatures treatment. The physical properties of the NaTNT and the AuNaTNT catalyst include BET surface area, pore volume, and T_{50%}, wherein the T_{50%} is the temperature for 50% CO conversion.

The BET surface area of the NaTNT and the AuNaTNT catalyst were measured with a Micromeritics (Model ASAP 2010) using N₂ as the adsorbate, and the pore size distributions were determined by the BJH method. The gold contents in the AuNaTNT catalysts were determined by neutron irradiation.

TABLE 1

| | BET surface area | Pore volume | T_{50%} |
|---|---|---|---|
| Catalysts | (m²/g) | (cm³/g) | (K) |
| Au383-S383-0.39 | 141 | 0.45 | 246 |
| Au383-S383-0.86 | 142 | 0.46 | 242 |
| Au383-S383-1.39 | 140 | 0.46 | 238 |
| Au383-S383-2.53 | 141 (144)^{a} | 0.45 (0.46)^{a} | 218 |
| Au383-S473-2.50 | 129 (131)^{a} | 0.43 (0.43)^{a} | 232 |
| Au383-S573-2.37 | 103 (106)^{a} | 0.42 (0.42)^{a} | 250 |
| Au383-S673-2.20 | 81 (83)^{a} | 0.36 (0.37)^{a} | 263 |
| Au473-S673-2.20^{b} | 85 | 0.34 | 270 |
| Au573-S673-2.20^{b} | 82 | 0.33 | 284 |
| Au673-S673-2.20^{b} | 80 | 0.35 | 292 |

^{a}The number in the parenthesis is the surface area and total pore volume for the NaTNT support.
^{b}These catalysts are prepared by calcining Au at 473 K, 573 K, and 673 K, respectively.

Table 1 shows the surface area and pore volume of 383 K dried NaTNT were 144 m²/g and 0.46 cm³/g, respectively, and decreasing to 83 m²/g and 0.37 cm³/g after calcining at 673 K. The surface area decrease is mainly due to the loss of small pore. Table 1 also discloses there are no significant change of the surface area and pore volume of the NaTNT after introducing the gold particles into the NaTNT by ion exchange. Furthermore, introducing gold nanoparticles onto the NaTNT by ion exchange do not block the pore of the NaTNT to any significant extent.

### Characterization of Phase Composition of NaTNT and AuNaTNT

FIG. 4 is X-ray powder diffraction (XRD) spectrum of the gold catalysts prepared by hydrothermal and washed in deionized water and calcined within a range from 383 K to 673 K for 3 hours. The XRD patterns of NaTNT were obtained using a spectrometer with Cu Kα irradiation (λ=1.5418 Å) at 30 kV and 30 mA.

Spectra (a) of FIG. 4 is an XRD result for NaTNT calcined at 383K. The result resembles sodium trititanate (Na₂Ti₃O₇) as reported by X. Sun et al. (2003), and Q. Chen et al., (2002). FIG. 4 shows the calcination temperatures increasing from 383 K to 673 K caused no significant change in XRD spectra except that the diffraction peak at 2θ=9.9° shifted slightly to a larger angle at 2θ=10.30. The peak at 2θ=9.9° was due to the reflection of (200) lattice plane and the shift toward a higher diffraction angle was attributed to the dehydration of the OH group in NaTNT leading to a smaller interlayer distance in the nanotube wall. The identification of crystalline phase of the nanotube by XRD is consistent with the observed lattice fringe of the material in HRTEM experiment, confirming that the crystal phase of the nanotube is a sodium trititanate.

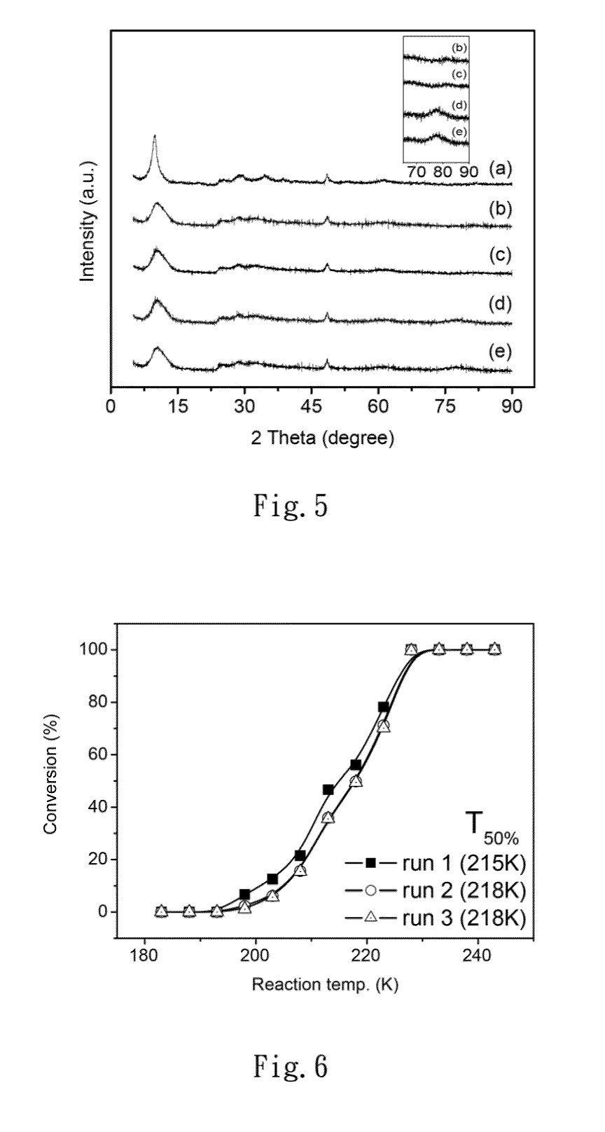

FIG. 5 is an XRD spectra of AuNaTNT catalyst calcined at temperatures from 383 K to 673 K. Spectrum (a) of FIG. 5 shows an XRD result of an AuNaTNT catalyst (Au383-S383-2.53) that was dried at 383 K, and spectrums (b), (c), (d), (e) are XRD results of AuNaTNT catalysts calcined at 383 K, 473 K, 573 K, and 673 K for 3 hours, respectively. The Au particles of low-temperature-calcined AuNaTNT catalyst are too small to be detected by XRD and thus not shown in FIG. 5. However, the Au particles start to sinter at a temperature from 573 K to 673 K and a broad, weak peak appears at 2θ=77.5°, which corresponds to the reflection of Au (311) plane.

### Measurements of Catalytic Activity of AuNaTNT Catalysts

FIG. 6 is a diagram of the CO conversions and the corresponding temperature profiles for an active AuNaTNT catalyst containing 2.53 wt % Au. According to one embodiment of the present invention, to perform a pretreatment, 50 mg of catalyst was packed inside an U-shape quartz reactor held by a quartz wool plug, and was dried at 393 K in 10 vol. % O₂/He at a flow rate of 30 ml/min for 1 h. After the pretreatment, 10 vol. % O₂/He continuously flowed through the catalyst bed, while the temperature of the oven was controlled in a range of from 183 K to 393 K at an interval of 5 K. After the reactor was operated isothermally, the gaseous mixture containing 1 vol. % CO in He (0.34 μmol CO/pulse) was pulsely injected into the O₂/He gas stream through the sampling loop to convert CO to CO₂. The product mixture was analyzed by an on-line quadrupole mass spectrometer, and the average value of the two CO conversions was adopted as the basis of the conversion at the temperature. Such pulse experiment was repeated three times for each catalyst so that a total of 258 data points were collected in a single activity test. The CO conversions were calculated based on the amount of CO₂ produced according to the following equation:

CO conversion (%)=(ACO₂/ACO_{2, 100%})×100,

where ACO₂ indicates the peak area of CO₂ (m/e=44), and ACO_{2, 100%} indicates the peak area of CO₂ corresponding to 100% conversion of CO (m/e=28).

Although the data points collected at the temperature higher than 243 K are not plotted in FIG. 6 for clarity, the CO conversion obtained over this catalyst has already reached 100% at 228 K. According to FIG. 6, AuNaTNT catalyst starts to oxidize CO to CO₂ at a temperature as low as 198 K with a T_{50%} of 215 K. On the other hand, the CO conversions and the corresponding temperature profiles of second and third run of the activity tests almost overlap and the T_{50%} lays slightly higher at 218 K. The results indicate that the catalyst has reached a stable activity after first run of the activity tests. Since the gold content in 2.53 wt % AuNaTNT is 6.42 μmol, it requires a maximum amount of 9.63 μmol of CO to reduce the gold oxide in AuNaTNT to metallic gold (Au₂O₃+3CO→2Au+3CO₂).

Gold oxide such as Au₂O₃ was known to be able to oxidize CO to CO₂ at ambient temperature. If gold oxide reduction is proceeding, it should be completed in the first run of the catalytic test (at the 29th pulse of CO). The color of AuNaTNT was purple after drying at 393 K in the flowing O₂, and turned into darker purple after the CO oxidation reaction. Therefore, the CO conversions in the first run of the catalytic test (refer to curve “run 1” of FIG. 6) might be partly due to stoichiometric reduction of gold oxide into metallic gold, and those in the run 2 and run 3 should represent the true catalytic activity of AuNaTNT catalyst in the CO oxidation reaction. Accordingly, only the CO conversions obtained in the run 3 of the activity test would represent the embodiment.

### Effect of Au Loading on the Catalytic Activity

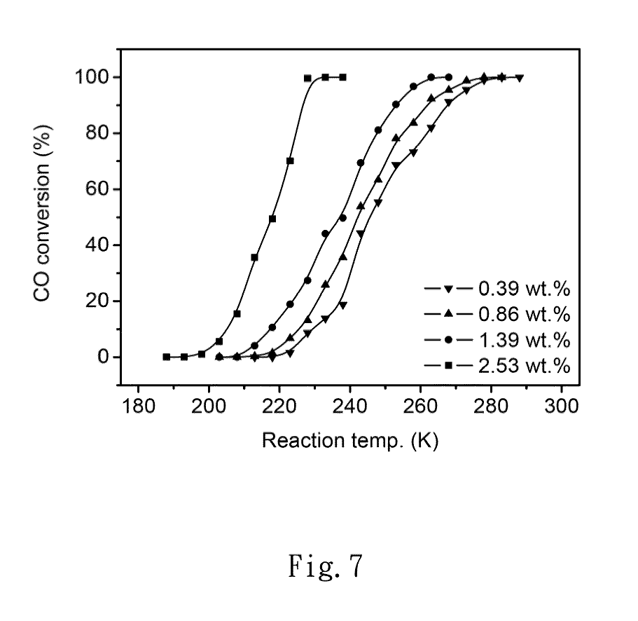

FIG. 7 is a diagram of the CO conversions and the corresponding temperature profiles for AuNaTNT catalysts with different Au loadings. FIG. 7 shows the AuNaTNT catalysts dried at 393 K with gold content in a range from 0.39 wt % to 2.53 wt % were active for CO oxidation below the room temperature. The activities of AuNaTNT catalysts increased with the Au loading, as shown in FIG. 7, T_{50%} of AuNaTNT catalyst with 2.53 wt % Au was 218 K, while that of 0.39 wt % Au was 246K. The results are the same as observed over Au/TiO₂ with similar gold loading but prepared by deposition precipitation method.

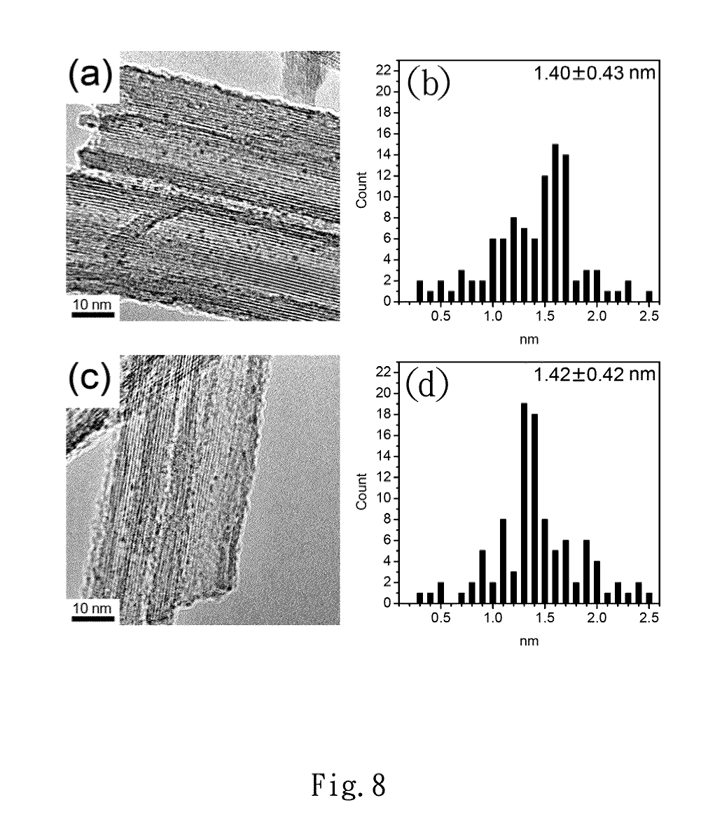

FIG. 8 is a diagram comprises the TEM images and the Au particle size distributions of two AuNaTNT catalysts with different Au loadings. FIG. 8 (a) shows the morphology of an AuNaTNT catalyst with 1.39 wt % Au, and (b) is the Au particle size distributions in the (a); (c) shows the morphology of an AuNaTNT catalyst with 0.39 wt % Au, and (d) is the Au particle size distributions in the (c). The TEM investigations revealed that for AuNaTNT in this Au loading range, an increase in Au loading mainly increased its Au particle density but did not change the Au particle size appreciably. As shown in the (a)-(b) of FIG. 8, the Au particle density of AuNaTNT catalyst with 1.39 wt % Au is 0.022 nm⁻², and the average Au particle diameter is 1.40±0.43 nm. The (c)-(d) of FIG. 8 shows the Au particle density in AuNaTNT catalyst with 0.39 wt % Au is 0.011 nm⁻², and the average Au particle diameter is 1.42±0.42 nm. Accordingly, the ion exchange method of the embodiment of the present invention is capable of producing very small Au particles with highly undercoordinated sites on the NaTNT surface. Furthermore, a higher Au particle density will result in a longer perimeter at the Au particle-NaTNT interface, which facilitates the adsorption of more O₂ molecules and further enhances the catalytic activity.

### Effect of Support Calcination Temperature on the Catalytic Activity

The basic role of oxide support is to provide sites for anchoring gold particles in order to increase the Au metal surface area, and in consequence, to produce a lager number of undercoordinated Au atoms. Prior to the ion exchange of gold, the NaTNT support was calcined at various temperatures at a range from 383 K to 673 K, and the calcination temperature of the NaTNT support may affect the NaTNT support.

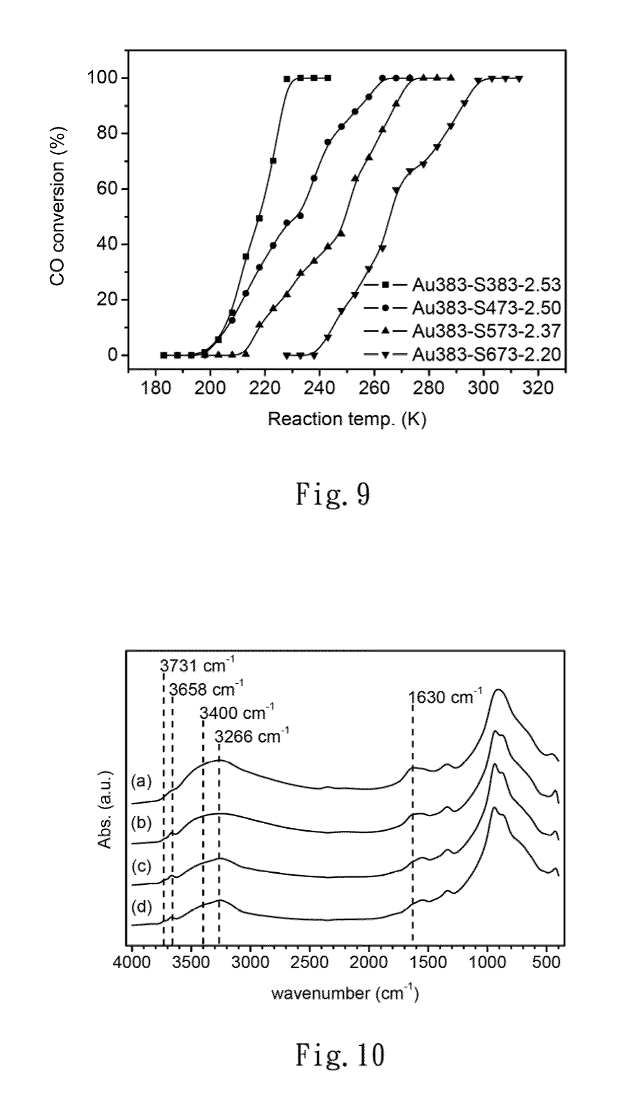

FIG. 9 is a diagram of the variation in CO conversions with respect to the NaTNT supports calcination temperatures (383 K-673 K) of various AuNaTNT catalysts, where T_{50%} for catalysts varied from 218 K to 263 K. The result of FIG. 9 indicates that the most active catalyst is the Au supported on NaTNT calcined at 383 K. The XRD in FIG. 4 discloses the higher calcination temperature reduced the interlayer distance of (200) lattice plane of NaTNT support, but did not change the phase composition. Calcination did result in the loss of the surface area and pore volume of NaTNT support (see Table 1), which might lead to a smaller Au loading in AuNaTNT and a lower activity. The Au loading, however, decreased only slightly from 2.53% for NaTNT dried at 383 K to 2.20% for that calcined at 673 K.

FIG. 10 is a diffuse reflectance infrared Fourier transformation (DRIFT) spectrum of NaTNT supports calcined at various temperatures. The NaTNT supports calcined at calcined at (a) 383 K, (b) 473 K, (c) 573 K, and (d) 673 K. To perform the DRIFT analysis, 50 mg of catalyst powder was evacuated (<6×10⁻⁵ torr) at 383 K for 1 h prior to the spectra recording. DRIFT spectrum were recorded using a resolution of 4 cm⁻¹ and 128 scans. FIG. 10 demonstrates the calcination of NaTNT lowered its moisture content. As shown in FIG. 10, the peaks of the IR spectra at 1630 cm⁻¹ and 3400 cm⁻¹ are the deformation and stretching vibrations of adsorbed water, respectively. In addition, there are a broad peak at 3266 cm⁻¹ and two other smaller but sharper peaks at 3658 cm⁻¹ and 3731 cm⁻¹, which were attributed to hydrogen-bonded and isolated surface hydroxyl groups on NaTNT, respectively. The peak intensities of the adsorbed water and hydrogen-bonded hydroxyl groups decreased (but did not completely vanish) as the calcination temperature of NaTNT was increased from 383 K to 673 K.

### Effect of Calcination Temperature of Au Particles on the Catalytic Activity

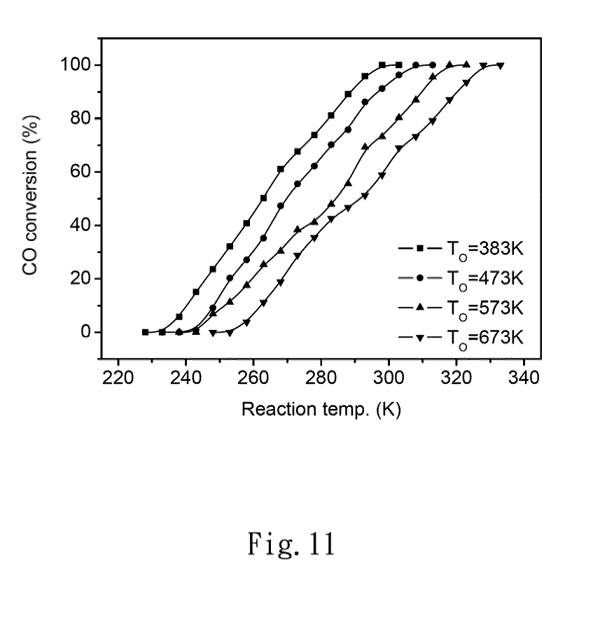

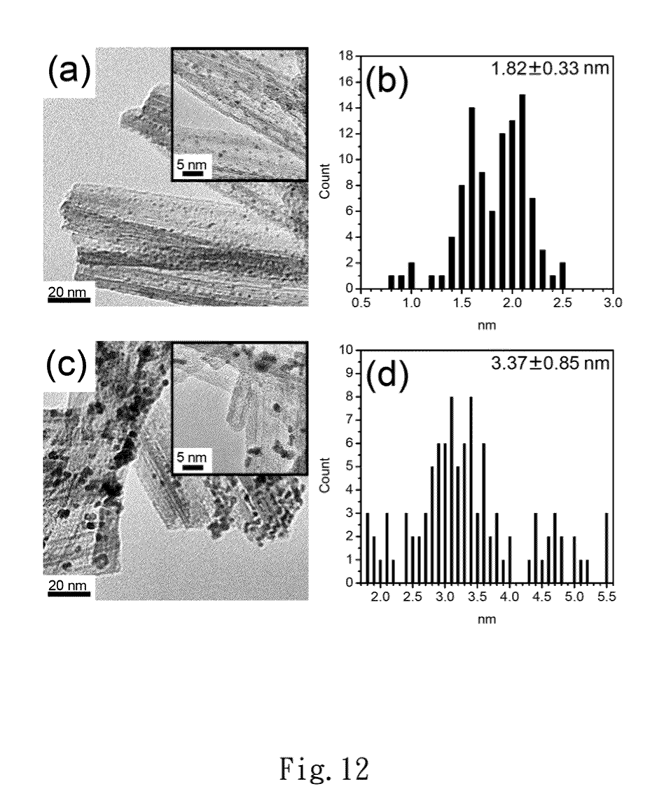

FIG. 11 is a diagram of variation of CO conversions with gold calcination temperature (Tₒ) for an AuNaTNT catalyst (Au383-S673-2.20) calcined from 383 K to 673 K. To avoid the support calcination effect, the NaTNT support used to prepare these AuNaTNT catalysts were calcined at 673 K before Au ion exchange. FIG. 11 indicates that T_{50%} of AuNaTNT increases as the calcination temperature of Au is increased, the T_{50%} for AuNaTNT dried at 393 K is 263 K and that calcined at 673 K is 292 K. The activity of AuNaTNT was reduced partly because the gold particle grew larger in size when the calcination temperature was increased in oxidizing or reducing environments. The result of FIG. 11 demonstrated that the AuNaTNT catalyst calcined at 673 K was capable of achieving 100% CO conversion at low temperature (350 K).

FIG. 12 is a diagram comprises the TEM images and the variation of gold particle size distributions with different gold calcination temperature. The (a) of FIG. 12 is the TEM image of AuNaTNT calcined at 473 K, and the (b) is the gold particle size distributions in the (a). The (c) of FIG. 12 is the TEM image of AuNaTNT calcined at 673 K, and the (d) is the particle size distributions in (c). The increase in Au particle size with calcination temperature increasing of AuNaTNT was indeed observed in of FIG. 12, which shows the average Au particle sizes for AuNaTNT calcined at 383 K (FIG. 2b), 473 K and 673 K were 1.51±0.25 nm, 1.82±0.33 nm and 3.37±0.85 nm, respectively. The results of FIG. 12 and FIG. 2 demonstrated that Au particle sizes of AuNaTNT were in a range from 0.5 nm to 5.5 nm. Due to the strong binding between the gold particle and the NaTNT, as shown in the (d) of FIG. 12, there is no Au particle with size greater than 6 nm produced in the AuNaTNT calcined at 673K. This might be the reason why even AuNaTNT calcined at 673 K still possessed the capability to oxidize CO at sub-ambient temperatures.

X-ray photoelectron spectroscopy (XPS) and X-ray absorption fine structure (XAFS) results indicated that the phase transformation of gold from Au(OH)₃ through Au₂O₃ to metallic gold with increasing calcination temperature over all the supported catalysts. To detect the variation of the gold oxidation state in the calcined AuNaTNT catalysts, an XPS analysis was performed.

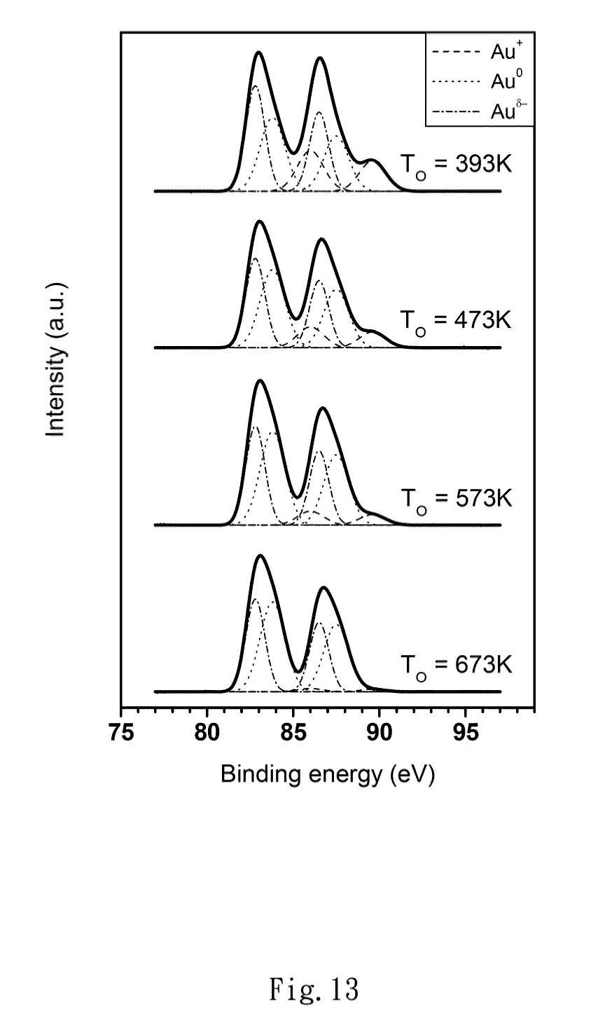

FIG. 13 is a diagram of variation of XPS signals of gold with different calcination temperatures of gold particles. The sample of XPS analysis is an AuNaTNT catalyst with 2.2 wt % and the NaTNT support was calcined at 673K before ion exchange with gold. FIG. 13 and Table 2 show there are three Au species on the AuNaTNT surface; the dashed line, dotted line, and dot-dashed line of the FIG. 13 represent the binding energy of three Au species, Au^{δ-}, Au⁰ and Auⁿ⁺ (n=1 or 3), respectively. The solid line represents the averaged binding energy of the three Au species on the AuNaTNT surface.

Refer to Table 2, the gold species with a 4f_{7/2} binding energy of 82.8 eV, whose value is even lower than that of the metallic gold by 1 eV, was assigned to a gold species with a negative oxidation state, Au^{δ-} state. The formation of such gold species was attributed to the transfer of the electron density from the support to the gold particle. In the embodiment of the present invention, the concentration of Au^{δ-} species did not change with calcination temperature and remained relatively constant at 40%. The XPS results are summarized in Table 2.

Table 2 shows the effect of calcination temperature on the oxidation states of Au and the distributions of different Au species in AuNaTNT catalysts.

TABLE 2

| Cal- | Binding energy and concentration of gold species | | | |
|---|---|---|---|---|
| cination | Au^{δ-} (mol %) | Au⁰ (mol %) | Au⁺¹ (mol %) | |
| temp. of | 4f_{7/2}: 82.8 eV | 4f_{7/2}: 83.8 eV | 4f_{7/2}: 86.0 eV | |
| AuNaTNT | 4f_{5/2}: 86.5 eV | 4f_{5/2}: 87.5 eV | 4f_{5/2}: 89.7 eV | Au⁺¹/Au⁰ |
| 383 K | 40.6 | 35.3 | 24.1 | 0.68 |
| 473 K | 40.7 | 46.3 | 13.0 | 0.28 |
| 573 K | 39.2 | 53.2 | 7.6 | 0.14 |
| 673 K | 39.5 | 56.7 | 3.8 | 0.07 |

According to Table 2, the concentration of Au⁺¹ specie decreased and metallic gold (the peak with a 4f_{7/2} binding energy at 83.8 eV) increased simultaneously as the calcination temperature of AuNaTNT increased. This fact clearly demonstrated that Au⁺¹ species are crucial in the sub-ambient CO oxidation reaction over AuNaTNT catalyst.

Although the XPS peak with 4f_{7/2} binding energy of 86.0 eV is assigned to Au⁺¹ in Table 2, in consideration of the overlapping binding energies for Au⁺¹ (such as AuCl) and Au⁺³ (such as Au₂O₃), the Au⁺³ may be produced in AuNaTNT catalysts. According to the embodiment of the present invention, the CO oxidation activity of AuNaTNT catalyst increased with gold loading. In addition, increasing gold loading increased gold particle density on NaTNT without changing the gold particle size appreciably. Calcination of the NaTNT support lowered its surface area but did not affect its capability to accommodate gold particles. However, calcining NaTNT at a temperature higher than 383 K caused activity loss of the catalyst, which was probably due to reduction of hydroxyl group and water content in AuNaTNT. The interaction between the gold particle and the NaTNT was probably strong, and calcining AuNaTNT at 673K did not produce gold particles larger than 6 nm.

XPS indicated there were three gold species, Au⁰, Auⁿ⁺ (n=1 or 3) and Au^{δ-}, in the AuNaTNT catalysts. Calcination of gold particles has no effect on the concentration of Au^{δ-} species, but higher calcination temperature will produce more Au⁰ species at the consumption of Au¹⁺ species. Lower concentration of Au¹⁺ species in AuNaTNT will decrease the catalytic activity of the AuNaTNT catalyst in the sub-ambient CO oxidation reaction.

In conclusion, small gold particles with sizes of 0.5 nm-10 nm could be prepared on the NaTNT surface by using the ion exchange method of the embodiment of the present invention. Three gold species with different oxidation state, Au⁰, Auⁿ⁺ (n=1 or 3) and Au^{δ-}, are loaded into the AuNaTNT catalyst. The Auⁿ⁺ species play an important role in the activity in the sub-ambient temperature region. The AuNaTNT catalyst could oxidize CO at sub-ambient temperatures, and most active gold catalyst (Au383-S383-2.53) according to one of embodiment of the present invention was able to achieve a T_{50%} of 218K.

Although the present invention has been described in considerable detail with reference to certain embodiments thereof, other embodiments are possible. Therefore, the spirit and scope of the appended claims should not be limited to the description of the preferred embodiments contained herein.

1-21. (canceled)

22. A metal oxide nanotube-supported gold catalyst, comprising:
a metal oxide support selected from the group consisting of sodium titanate nanotubes, bundles of the sodium titanate nanotubes, and combinations thereof; and
a plurality of gold particles loaded into the sodium titanate nanotubes, wherein the gold particles comprise Au^{δ-} species.

23. The metal oxide nanotube-supported gold catalyst of claim 22, wherein the gold particles comprise Auⁿ⁺ species, wherein n=1 or 3.

24. The metal oxide nanotube-supported gold catalyst of claim 22, wherein the gold particles comprise Au⁰ species.

25. The metal oxide nanotube-supported gold catalyst of claim 22, wherein the gold particles comprise Auⁿ⁺ and Au⁰ species, wherein n=1 or 3.

26. The metal oxide nanotube-supported gold catalyst of claim 22, wherein the size of gold particles in a range from about 0.5 nm to about 10 nm.

27. The metal oxide nanotube-supported gold catalyst of claim 22, wherein each sodium titanate nanotube comprises an outer diameter in a range from about 5 nm to about 15 nm, a hollow inside diameter in a range from about 3 nm to about 6 nm, and the bundles of the sodium titanate nanotubes with diameters in a range from about 20 nm to about 150 nm.

28. The metal oxide nanotube-supported gold catalyst of claim 22, wherein the calcination temperature of the metal oxide support is 383 K, and the calcination temperature of the gold particles loaded in the metal oxide support is 383 K.

29. The metal oxide nanotube-supported gold catalyst of claim 22, wherein the calcination temperature of the metal oxide support is 383 K, and the calcination temperature of the gold particles loaded in the metal oxide support is 473 K.

30. The metal oxide nanotube-supported gold catalyst of claim 22, wherein the calcination temperature of the metal oxide support is 383 K, and the calcination temperature of the gold particles loaded in the metal oxide support is 573 K.

31. The metal oxide nanotube-supported gold catalyst of claim 22, wherein the calcination temperature of the metal oxide support is 383 K, and the calcination temperature of the gold particles loaded in the metal oxide support is 673 K.

32. The metal oxide nanotube-supported gold catalyst of claim 22, wherein the calcination temperature of the metal oxide support is 473 K, and the calcination temperature of the gold particles loaded in the metal oxide support is 383 K.

33. The metal oxide nanotube-supported gold catalyst of claim 22, wherein the calcination temperature of the metal oxide support is 573 K, and the calcination temperature of the gold particles loaded in the metal oxide support is 383 K.

34. The metal oxide nanotube-supported gold catalyst of claim 22, wherein calcination temperature of the metal oxide support is 673 K, and the calcination temperature of the gold particles loaded in the metal oxide support is 383 K.

35. The metal oxide nanotube-supported gold catalyst of claim 22, wherein the gold particles loaded into the metal oxide support in an amount from about 0.3 weight percent to about 40.2 weight percent.
